(19) United States
(12) Patent Application Publication
(10) Pub. No.: US 2008/0186740 A1
(43) Pub. Date: Aug. 7, 2008

(54) Connecting assembly in light strings to maintain electrical connection

(75) Inventors: Shih-Chih Huang, Taipei (TW); Ping Yang, Guangdong (CN)

Correspondence Address: JACKSON WALKER, L.L.P., 112 E. PECAN, SUITE 2400, SAN ANTONIO, TX, 78205, US

(73) Assignee: Mike Huang

(21) Appl. No.: 11/703,483

(22) Filed: Feb. 7, 2007

(51) Int. Cl. H01R 33/00

(52) U.S. Cl. 362/652

(57) ABSTRACT

A lamp for a light string includes a V shaped spring with two ends movably received inside the passage of the socket to selectively engage with two connecting plates of two cables so as to maintain electrical engagement between the two connecting plates when the light bulb is removed from the passage of the socket.

### BACKGROUND OF THE INVENTION

1. Field of the Invention

The present invention relates to a connecting assembly, and more particularly to a connecting assembly in light strings to maintain electrical connection especially when one of more individual light bulbs are removed from the light socket.

2. Description of the Prior Art

Light strings having light bulbs electrically connected to one another in series are popular on festival seasons such as Christmas day, New Year . . . etc. In general, the light bulbs are electrically connected in series rather than in parallel. A major drawback of such connection is that when one individual light bulb is removed from the light socket for replacement or inspection, the entire light string fails to light. Only when the light bulb is inserted back into the light socket, can the entire circuit be completed and the light string is able to light.

One solution that allows the circuit to maintain complete is provided by U.S. Pat. No. 6,257,740 ('740 patent hereinafter) issued to Gibboney on Jul. 10, 2001. The structure shown in the '740 patent is depicted in FIG. 6, wherein a spring (60) is inserted in the light socket (50) having two connecting plates (51) oppositely engaged with an inner periphery of the light socket (50). The spring (60) is composed of two elongated arcuate terminals (61) respectively and firmly connected to extending out from a corresponding one of the two connecting plates (51). It is noted that a distal end of each of the two terminals (61) is connected to one another so as to maintain the two connecting plates (51) in electrical connection when the light bulb (40) is removed away from the light socket (50). As a consequence, even though when one individual light bulb (40) is removed from the light string, the entire circuit of the light string maintains and the light string lights.

However, a closer look into the structure of the '740 patent, it is noted that the proximal end of each of the two terminals (61) is firmly connected to the corresponding connecting plate (51) of the light socket (50) and the distal end of each of the two terminals (61) is detachably connected to one another. That is, only when the light bulb base is extended into the light socket (50), can the two terminals (61) be separated by the extension of the light bulb base. Because the two proximal ends of the two terminals (61) are affixed to the two connecting plates (51) respectively, the recovery force for the two distal ends of the two terminals (61) to maintain engagement becomes weaker and weaker as time goes. Eventually, the recovery force of the spring (60) can not bring back the two distal ends of the two terminals (61) once they are separated by the extension of the light bulb base therefore, the circuit of the light string is damaged.

To overcome the shortcomings, the present invention tends to provide an improved light string to mitigate the aforementioned problems.

### SUMMARY OF THE INVENTION

The primary objective of the present invention is to provide a light string having a connecting assembly received inside the light bulb socket to maintain the two connecting plates in electrical connection.

In order to accomplish the aforementioned objective, the present invention provides a spring movably received inside the light bulb socket to maintain two connecting plates in electrical connection at all times when one individual or more light bulbs are removed from the light bulb socket.

The spring has a substantially V shape and two free ends of which are alternately connected to the two connecting plates when the light bulb is extended into the light bulb socket so that the electrical connection between the two connecting plates are maintained.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an individual light bulb and a light bulb socket associated with the light bulb;

FIG. 2 is a schematic cross sectional view showing that the light bulb is to be extended into the light bulb socket;

FIG. 3 is a schematic cross sectional view showing that the light bulb is extended into the light bulb socket;

FIG. 4 is a schematic cross sectional view showing a different embodiment of the spring of the present invention;

FIG. 5 is a schematic cross sectional view showing that the light bulb is extended into the light bulb socket with the spring in FIG. 4; and

FIG. 6 is a schematic exploded side plan view of a conventional light bulb and the associated light bulb socket.

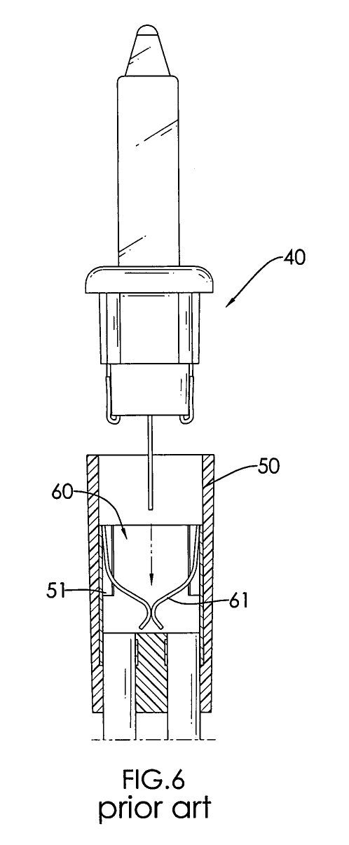

### DETAILED DESCRIPTION OF THE PREFERRED EMBODIMENT

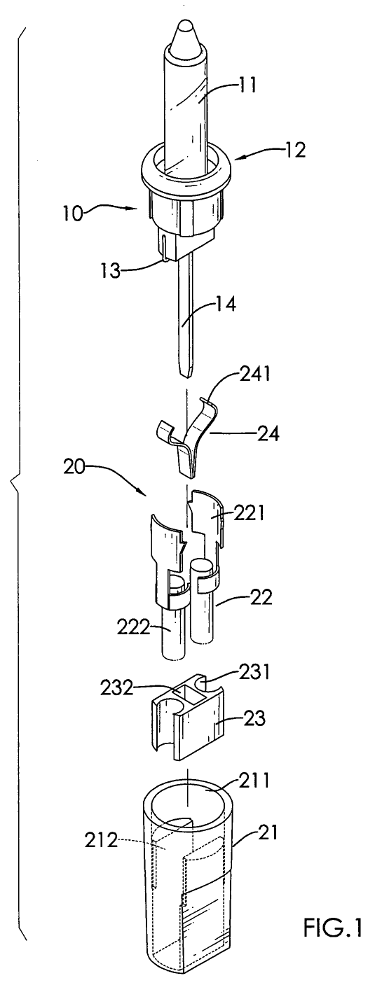

With reference to FIG. 1, it is noted that a lamp used in a light string and constructed in accordance with the present invention include a light bulb (10) and a light bulb socket (20).

The light bulb (10) is composed of a globe (11) and a base (12) firmly connected to a bottom face of the globe (11) and having two leads (13) extending out from the globe (11) and attached to opposed sides of the base (12). An extension (14) is integrally formed on a bottom face of the base (12) and extending downward opposite to that of the globe (11).

The light bulb socket (20) has a socket (21), two cables (22), a plug (23) and a spring (24).

The socket (21) is provided with two open ends, a passage (211) communicating with the two open ends and two shoulders (212) oppositely formed on an inner periphery defining the passage (211). Each cable (22) has a connecting plate (221) and an electrical wire (222) with the connecting plate (221) securely attached to a top end of the electrical wire (222). The plug (23) is received inside the passage (211) and has two cutouts (231) defined in opposed sides of the plug (23) and an indent (232) defined between the two cutouts (231). The spring (24) has a substantial V shape and each of two free ends of which is slightly deformed to have a bent (241).

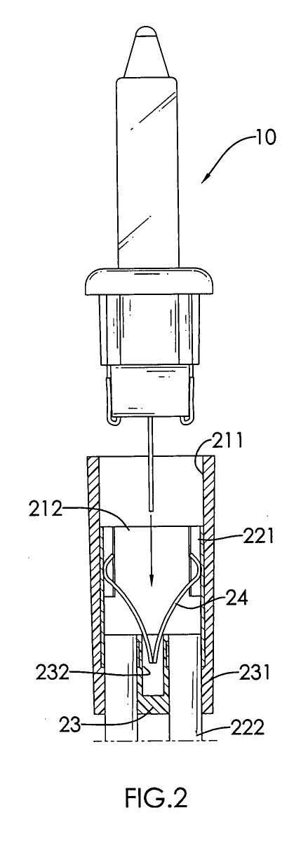

With reference to FIG. 2, it is noted that when the lamp of the present invention is to be assembled, the plug (23) is first received in the socket (21) with the two cables (22) respectively received in the two cutouts (231) and the electrical wires (222) extending out of the socket (21). After the electrical wires (222) are extended out of the socket (21), the two connecting plates (221) are located inside the passage (211) and between the two shoulders (212) to firmly attach to opposed sides of the inner periphery defining the passage (211). Thereafter, the spring (24) is extended into the passage (211) and received in the indent (232) with a waist of each arm of the spring (24) supported by a periphery of the indent (232). It is to be noted that after the spring (24) is extended into and received in the indent (232), the two bents (241), the two free ends of the spring (24), are respectively engaged with the two connecting plates (221) to maintain the two connecting plates (221) in electrical connection.

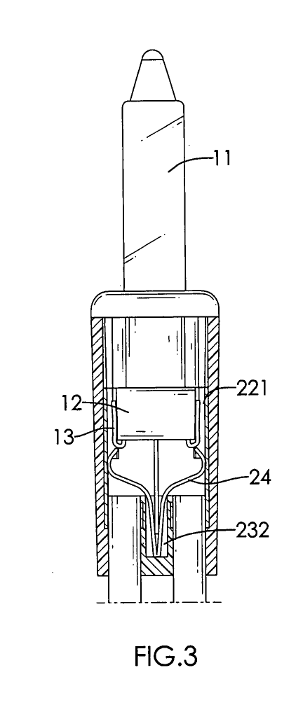

With reference to FIG. 3, it is noted that when the light bulb (10) is inserted into the passage (211) of the socket (21) with the extension (14) extending directly into the indent (232) of the plug (23), the two free ends of the spring (24) are pushed away from engagement with the two connecting plates (22) by the base (12) leaving the two leads (13) to engage with the connecting plates (221). After the spring (24) is pushed away from engagement with the two connecting plates (221), the spring (24) is forced by the base (12) to extend into the indent (232) of the plug (23) and be detached with the two connecting plates (221), which deforms the spring (24). Therefore, when the light bulb (10) is removed from the socket (21), the recovery force stored inside the spring (24) when the spring (24) is deformed lifts itself out of the indent (232) and returns to its original position. That is, before the extension of the light bulb (10) into the socket (21), the spring (24) keeps the two connecting plates (221) in electrical connection and after the light bulb (10) is extended into the socket (21) of the light bulb socket (20), the leads (13) maintain the electrical connection between the two connecting plates (221). Therefore, the two connecting plates (221) are thus maintained in electrical connection at all times even though one or more individual light bulbs are removed from the light bulb socket (20).

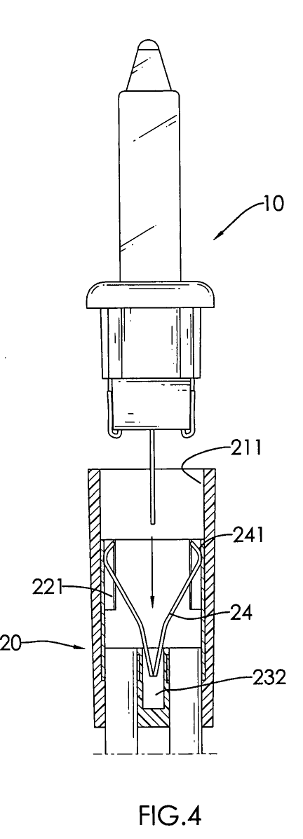

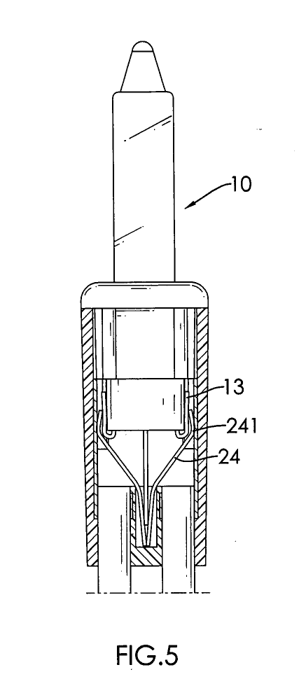

With reference to FIGS. 4 and 5, it is noted that before the extension of the light bulb (10) into the passage (211) of the socket (21), the bents (241) of the spring (24) respectively engage with the two connecting plates (221) to keep the two connecting plates (221) in electrical connection so that when the light bulb (10) is removed from the light bulb socket (20), the two connecting plates (221) are still electrically engaged with each other and the light string is lit.

After the extension of the light bulb (10) into the passage (211) of the socket (21), the base (12) does not push away the two bents (241) of the spring (24). Instead, the base (12) pushes the spring (24) further down into the indent (232) of the plug (23) and the two leads (13) of the light bulb (10) engage with the two bents (241) to have electrical connection with the two connecting plates (221). Therefore, it is noted that no matter it is before or after the light bulb (10) is removed from the light bulb socket (20), the two bents (241) of the spring (24) remain engagement with the two connecting plates (221), which maintains the two connecting plates (221) in electrical connection and to keep the circuit of the lamp complete.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lamp for a light string, the lamp comprising:
a light bulb composed of a globe and a base firmly engaged with a bottom of the globe and provided with two leads extending out of the globe and arranged in two opposed sides of the base and an extension extending integrally from a bottom of the base; and
a light bulb socket having a socket with two open ends, a passage in communication with the two open ends, a plug securely received in the passage and having two opposed cutouts receiving therein two electrical wires each having a connecting plate securely attached to a top end thereof and extending out of the two cutouts and an indent defined in the plug and between the two cutouts and a V-shaped spring movably received in the indent and having two ends extending out of the indent of the plug to selectively engage with the two connecting plates such that when the base of the light bulb is extended into the passage, the two ends of the spring are pushed away from engagement with the two connecting plates and the spring is extended further into the indent of the plug to have a deform, the two leads are engaged with the two connecting plates to maintain electrical engagement between the two connecting plates and when the light bulb is removed from the passage, the two ends of the spring are lifted by a recovery force of the spring when deformed to engage with the two connecting plates to maintain the two connecting plates in electrical connection.

2. The lamp as claimed in claim 1, wherein the spring is supported by two shoulders formed on two opposed inner sides of the socket when the spring is deformed.

3. The lamp as claimed in claim 1, wherein the spring is supported by two shoulders formed on two opposed inner sides of the socket when the spring is deformed and the two connecting plates are respectively sandwiched by the two shoulders.

4. A lamp for a light string, the lamp comprising:
a light bulb composed of a globe and a base firmly engaged with a bottom of the globe and provided with two leads extending out of the globe and arranged in two opposed sides of the base and an extension extending integrally from a bottom of the base; and
a light bulb socket having a socket with two open ends, a passage in communication with the two open ends, a plug securely received in the passage and having two opposed cutouts receiving therein two electrical wires each having a connecting plate securely attached to a top end thereof and extending out of the two cutouts and an indent defined in the plug and between the two cutouts and a V-shaped spring movably received in the indent and having two ends extending out of the indent of the plug to engage with the two connecting plates such that when the base of the light bulb is extended into the passage, the spring is extended further into the indent of the plug to have a deform, the two leads are engaged with the two ends of the spring to maintain electrical engagement between the two connecting plates.

5. The lamp as claimed in claim 4, wherein the spring is supported by two shoulders formed on two opposed inner sides of the socket when the spring is deformed.

6. The lamp as claimed in claim 4, wherein the spring is supported by two shoulders formed on two opposed inner sides of the socket when the spring is deformed and the two connecting plates are respectively sandwiched by the two shoulders.
